(19) United States
(12) Patent Application Publication
(10) Pub. No.: US 2007/0138903 A1
(43) Pub. Date: Jun. 21, 2007

(54) Rotor assembly of brushless motor

(75) Inventor: Chao-Pi Chang, Nan Tou City (TW)

Correspondence Address: LEONG C LEI, PMB # 1008, 1867 YGNACIO VALLEY ROAD, WALNUT CREEK, CA, 94598, US

(73) Assignee: HEADLINE ELECTRIC CO., LTD.

(21) Appl. No.: 11/311,318

(22) Filed: Dec. 20, 2005

(51) Int. Cl. H02K 1/22

(52) U.S. Cl. 310/261

(57) ABSTRACT

A rotor assembly of a brushless motor is provided herein, which contains an axle, a rotor encircling the axle coaxially, and a layered structure therebetween tightly joining the rotor and the axle together. The layered structure contains an inner cladding, a plastic member, and an outer cladding, arranged coaxially in this order around the axle. The plastic member, due to its flexibility, functions as a cushion between the rotor and the axle to absorb both the noise and the vibration of the rotor. As such, the present invention achieves a silent brushless motor without imposing any constraint on the motor's rotational speed.

### BACKGROUND OF THE INVENTION

(a) Technical Field of the Invention

The present invention generally relates to brushless motors, and more particularly to the rotor assembly of a brushless motor.

(b) Description of the Prior Art

As shown in FIGS. 5-7, the rotational mechanism of a conventional brushless motor mainly contains a rigid rotor 20 usually made of iron oxide, a rigid core 21 encircled by the rotor 20 coaxially, and an axle 22 going through and at the axis of the core 21. Then, under the attracting and repelling forces produced between the electromagnetic poles (not shown) of the rotor 20 and the permanent magnets (not numbered) arranged around the rotor 20, the rotor 20, the core 21, and the axle 22 are rotated around the axis of the axle 22. As they spin, the noise resulted from the vibration of the rotor 20 and the core 21 would be transmitted to the outside of the brushless motor via the axle 22. In addition, as the brushless motor itself would vibrate as well under the influence of the vibration of the rotor 20 and the core 21, a very loud noise would be produced when the vibration frequency of the brushless motor resonates with the vibration frequency of the rotor 20 and the core 21. When the brushless motor is operated to undergo continuous rotational speed changes, the loudness of the noise would vary as resonance occurs periodically. To overcome the loud and varying-pitched noise, the rotational speed of a conventional brushless motor is usually regulated so as to prevent the occurrence of the periodical resonance. However, the flexibility of the brushless motor to have arbitrary rotation speed is compromised by such limitation.

### SUMMARY OF THE INVENTION

The primary purpose of the present invention is to provide a novel rotor assembly to obviate the annoying noise problem of a conventional brushless motor.

The rotor assembly contains an axle, a rotor encircling the axle coaxially, and a layered structure therebetween tightly joining the rotor and the axle together. The layered structure contains an inner cladding, a plastic member, and an outer cladding, arranged coaxially in this order around the axle. The plastic member, due to its flexibility, functions as a cushion between the rotor and the axle to absorb both the noise and the vibration of the rotor. As such, the present invention achieves a silent brushless motor without imposing any constraints on the rotational speed.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the rotor assembly according to an embodiment of the present invention.

FIG. 2 is a sectional view showing the rotor assembly of FIG. 1.

FIG. 3 is a perspective view showing the rotor assembly of FIG. 1 housed inside a brushless motor.

FIG. 4 is a cross-sectional view showing the rotor assembly of FIG. 1.

FIG. 5 is a perspective view showing a conventional rotor assembly.

FIG. 6 is a sectional view showing the conventional rotor assembly of FIG. 5.

FIG. 7 is a perspective view showing the conventional rotor assembly of FIG. 5 housed inside a brushless motor.

FIG. 8 is a graph comparing the noise produced by a conventional rotor assembly and the present invention under various rotational speeds.

FIG. 9 is a graph comparing the vibration produced by a conventional rotor assembly and the present invention under various rotational speeds.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

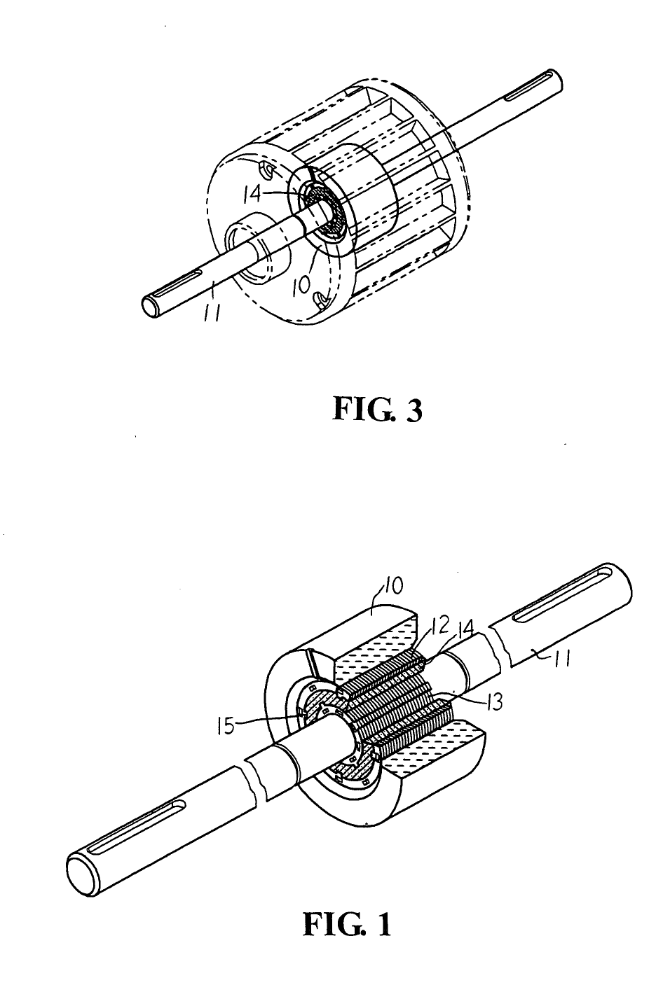

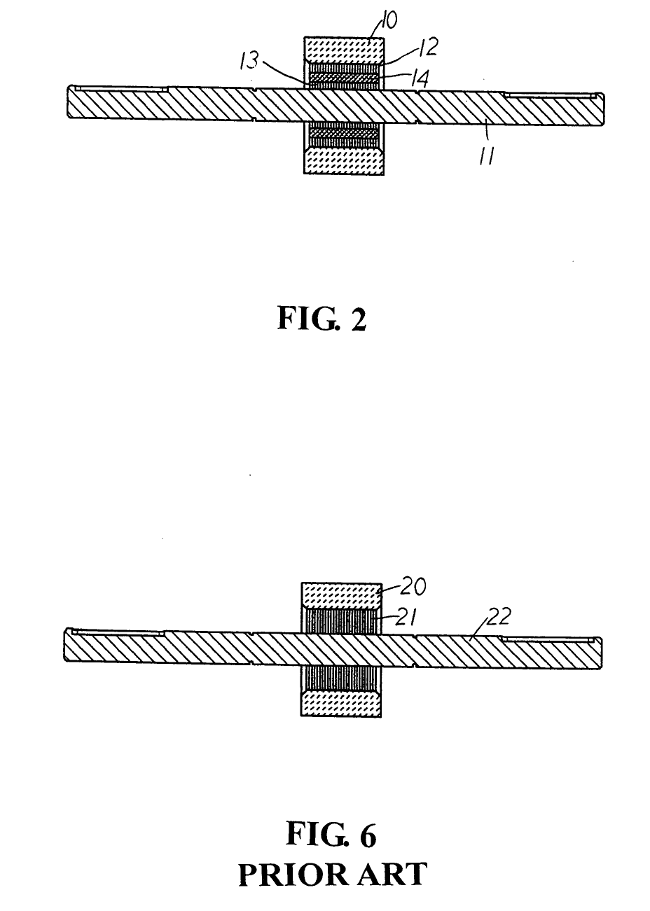

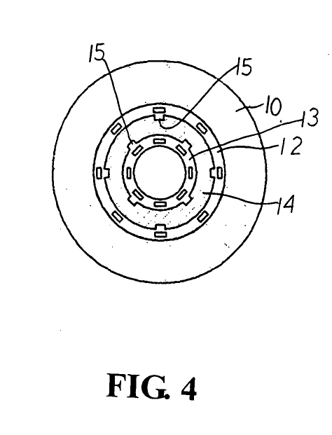

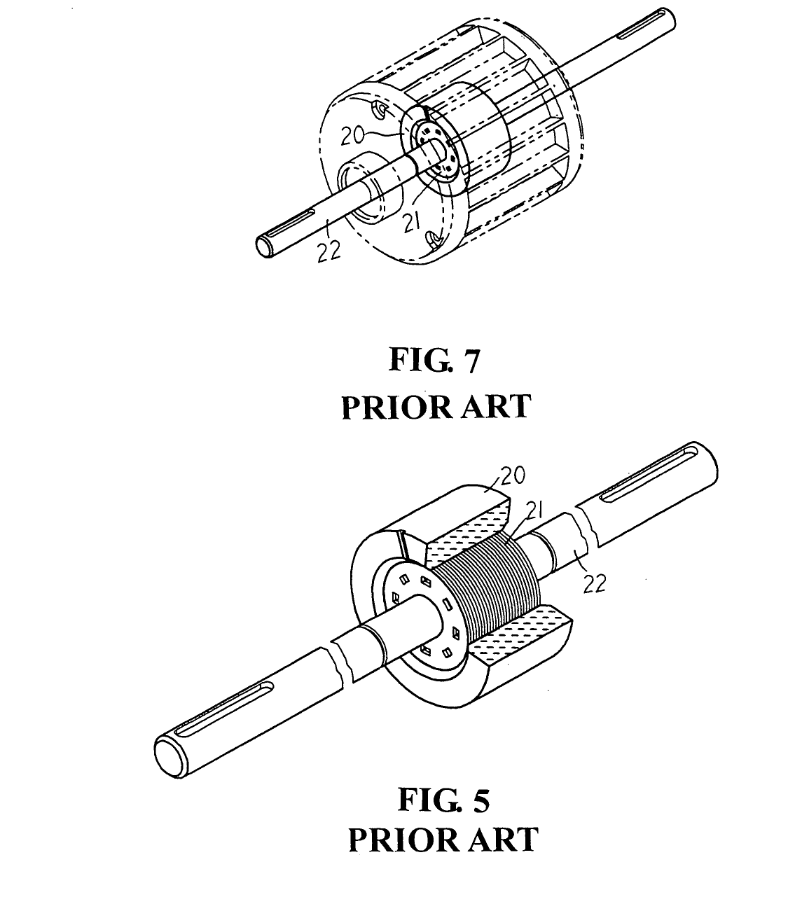

As shown in FIGS. 1˜3, the rotor assembly according to an embodiment of the present invention contains an axle 11 and a rotor 10 encircling the axle 11 coaxially, as in a conventional brushless motor. The rotor assembly further contains a layered structure configured between and tightly joining the rotor 10 and the axle 11 together. The layered structure in turn contains an inner cladding 13, a plastic member 14, and an outer cladding 12, arranged coaxially in this order around the axle 11. Alternatively, a number of ribs 15 are configured axially around the inner wall of the outer cladding 12 and around the outer wall of the inner cladding 13 respectively, and the ribs 15 on the outer cladding 12 and those on the inner cladding 13 are interleaved, as shown in FIG. 4. Please note that, instead of protruding ribs, indented troughs could also be used. As such, in the manufacturing process of the rotor assembly, the cohesion of the rotor assembly is enhanced as the plastic member 14 is filled between the injection-molded inner and outer claddings 13 and 12.

The major characteristic of the present invention is that the plastic member 14, due to its flexibility, functions as a cushion between the rotor 10 and the axle 11 to absorb both the noise and the vibration of the rotor 10. As most of the vibration of the rotor assembly is removed by the plastic member 14, the resonance of the brushless motor rarely happens, if not entirely avoided. In addition, as such, the already quieter noise of the present invention is not reinforced by the resonance of the vibration frequencies and the overall effect is that the present invention achieves a silent brushless motor without imposing any constraints on the rotational speed.

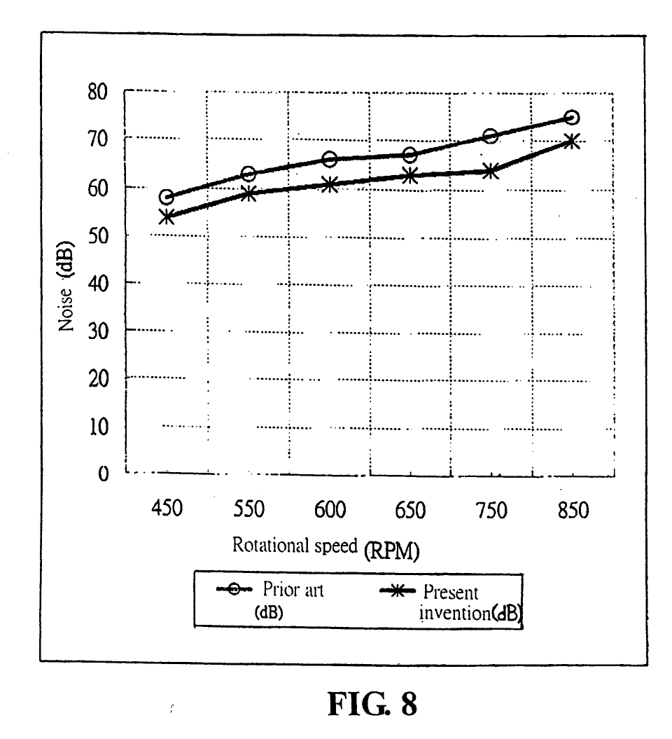

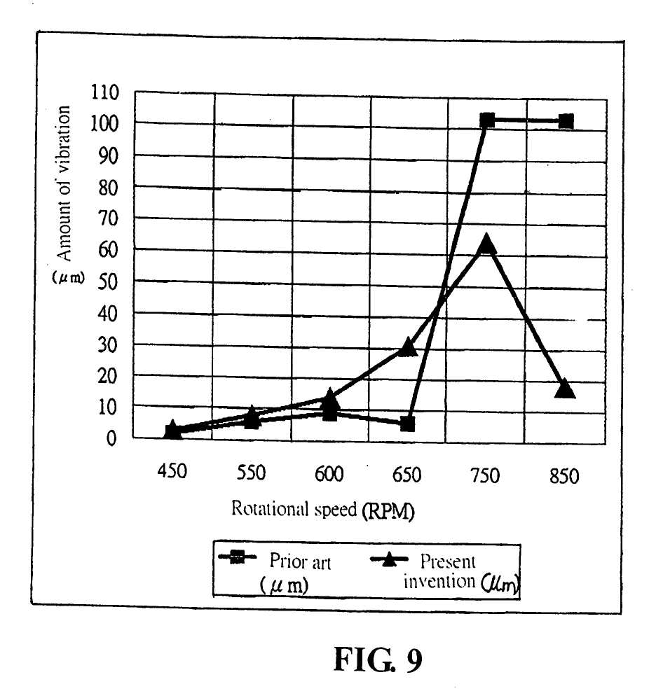

To illustrate the improvement provided by the present invention, the noise and vibration produced by a conventional rotor assembly and those by the present invention under various rotational speeds are compared in FIGS. 8 and 9 respectively. As depicted in FIG. 9, the amount of vibration is significantly reduced when the brushless motor is running at high speeds. On the other hand, the present invention constantly delivers less noise when running at both high and low speeds.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A rotor assembly of a brushless motor, comprising:
an axle;
a rotor arranged coaxially and encircling said axle; and
a layered structure configured between and tightly joining said rotor and said axle together, said layered structure comprising an inner cladding, a plastic member, and an outer cladding, arranged coaxially in this order around said axle.

2. The rotor assembly according to claim 1, wherein a plurality of ribs are configured axially around the inner wall of said outer cladding and around the outer wall of said inner cladding respectively; and said ribs on said outer cladding and those on said inner cladding are interleaved.

3. The rotor assembly according to claim 1, wherein a plurality of troughs are configured axially around the inner wall of said outer cladding and around the outer wall of said inner cladding respectively; and said troughs on said outer cladding and those on said inner cladding are interleaved.
